(19) United States
(12) Patent Application Publication
(10) Pub. No.: US 2013/0062183 A1
(43) Pub. Date: Mar. 14, 2013

(54) Clip device

(71) Applicants: Bert W. Wechtenhiser, Jacksonville, FL (US); James A. King, Jacksonville, FL (US)

(72) Inventors: Bert W. Wechtenhiser, Jacksonville, FL (US); James A. King, Jacksonville, FL (US)

(73) Assignee: Dwyer Precision Products, Inc., Jacksonville Beach, FL (US)

(21) Appl. No.: 13/199,740

(22) Filed: Sep. 9, 2011

(51) Int. Cl. H01H 35/24; F16B 2/22

(52) U.S. Cl. 200/81 R; 24/499; 24/518

(57) ABSTRACT

A clip device for retaining and clamping a tube, e.g. a pneumatic hose of a pneumatically actuated switching device to an object, e.g. an area of a patient's bed, comprises a pair of opposed clip members; a biasing member integrally connected to the opposed clip members; a locking post; and a locking mechanism for receiving and retaining the locking post and clip members in a closed position. The proximal ends of the clip members have intermeshing teeth for attaching the clip device to the object and the distal ends have a gripping area for pressing the clip members together. The biasing member has a circular body with gripping elements for gripping the tube. The locking post is made of a rigid yet flexible material for keeping the distal ends of clip members apart and in a locked condition when the locking post is engaged in the locking mechanism.

### BACKGROUND OF THE INVENTION

1. Field of the Invention

The invention relates to a clip device. More specifically, the invention relates to a clip device constructed to retain and clamp a tube, such as, for example, a pneumatic hose, to an object, such as, for example, to a bed sheet of a bed.

2. Description of the Prior Art

Hospitals and other patient-care institutions frequently provide patient call systems wherein a patient may activate a signal to a central station, such as a nurse's station, to summon assistance. The use of conventional electrical switches to generate the signal in such environments is undesirable given the potentially combustible levels of oxygen that may likely be present near the patient.

An alternative to conventional electrical switches involves the use of a pneumatically actuated switching device which utilizes a pulse of pressurized air to actuate a signal circuit and which avoids the safety concerns associated with the conventional electrical switch. Such pneumatically actuated switches are particularly beneficial where combustion concerns may be present, as in oxygen rich environments, because the construction of the pneumatically actuated switch limits the possibility of arcing which is a problem associated with conventional electrical switches.

Examples of pneumatically actuated switches which comprise a pneumatic hose which is connected to a source of pneumatic pressure for actuation of a signal circuit are disclosed in U.S. Pat. Nos. 3,823,285; 5,155,309; 5,736,702; and 5,999,100. The source of pneumatic pressure generally includes a pneumatic actuator in the form of a deformable bulb or dome which is compressed manually by the patient for providing the pressurized air to an electrical switch for signaling for assistance at the nurse's station. In some instances, it is desirable to retain the deformable bulb or dome on top of the patient's bed. Presently, this may be accomplished by providing a clip device which supports the pneumatic hose and which clamps the pneumatic hose to the bed, for example, to the bed sheet or blanket. An example of a clip device of the prior art for this purpose may be made of stainless steel and in general includes first and second clamp members, each having a bore in which the pneumatic hose is inserted prior to attachment of the deformable bulb and/or prior to attachment of the electrical switching device to the pneumatic hose in assemblage of the pneumatically actuated switch. A disadvantage of this kind of clip device is that the pneumatic hose cannot be attached to the clip device after the deformable bulb and the electrical switch have been assembled and attached to the opposed ends of the pneumatic hose. A further disadvantage of the present clip device is that it does not contain a locking mechanism for retaining the jaws or clip members in a closed position so that the clip device is prevented from becoming dislodged from the object in which the clip device is attached, such as the bed sheet or blanket of a patient's bed.

There is a need in the art to provide a clip device for attaching a tube, such as a pneumatic hose of a pneumatically actuated switching device to an object, such as, a bed sheet or blanket of a patient's bed for manual operation of the pneumatically actuated switching device.

There is a further need in the art to provide a clip device for attaching an article to an object that includes a locking mechanism for retaining the jaws or clip members in a locked, closed position.

### SUMMARY OF THE INVENTION

The invention has met these needs. The present invention provides a pneumatically actuated switching device having a pneumatic actuator, which may be in the form of a deformable bulb, for creating pressurized air for activating an electrical signal when the pneumatic actuator is operated and having a pneumatic hose for delivering the pressurized air to an electrical switch for activating an electrical signal. The pneumatically actuated switching device comprises a clip device for securing and clamping the pneumatic hose to a patient's bed. The clip device comprises a pair of opposed clip members including a first clip member and a second clip member; a biasing member integrally connected to the first clip member and the second clip member and having a substantially circular body for receiving and retaining the pneumatic hose; a locking post extending from the first clip member; and a locking mechanism located on the second clip member for receiving and retaining the locking post and retaining the pair of opposed clip members in a spaced apart closed position for retaining the pneumatic hose in the clip device. The first and second clip members comprise a proximal end and a distal end. The proximal ends have intermeshing teeth for clamping the clip device in the area of the patient's bed, and the distal ends comprise a gripping area for pressing the distal ends together for opening the proximal ends of the clip members for insertion and/or removal of the pneumatic hose from the biasing member. The biasing member comprises a plurality of elongated elements for gripping the pneumatic hose in position within the substantially circular body of the biasing member. The locking post is made of a relatively rigid material for retaining the distal end of each clip member in a spaced apart relationship when the locking post is engaged in the locking mechanism and for retaining the proximal end of each clip member in a closed relationship for retaining the pneumatic hose within the clip device while clamping the clip device to the area of the patient's bed. The clip device may be made via a molding process and may be made of a plastic material.

A further aspect of the invention provides a clip device for retaining and clamping an article to an object. The clip device comprises opposed clip members including a first clip member and a second clip member; a biasing member connected to the first clip member and the second clip member and having a body for receiving and retaining the article; a locking post extending from the first clip member; and a locking mechanism located on the second clip member for receiving and retaining the locking post and retaining the opposed clip members in a spaced apart closed position for retaining the article in the clip device and the clip device to the object. The clip members comprise a proximal end and a distal end. The proximal ends comprise intermeshing teeth for clamping the clip device to the object, and the distal ends comprise a gripping area for pressing the distal ends together for opening the proximal ends for insertion and/or removal of the article from the body of the biasing member. The biasing member comprises a plurality of elongated elements for gripping the article in position within the body of the biasing member. The locking post is made of a relatively rigid material for retaining the distal ends of the clip members in a spaced apart relationship when the locking post is engaged in the locking mechanism and for retaining the proximal ends of the clip members in a closed relationship for retaining the article within the body of the biasing member while securing the clip device to the object. The clip device may be made via a molding process, may be comprised of a plastic material; and comprises an integral construction.

A still further aspect of the present invention is to provide a clip device for retaining a tubular article and for clamping the tube to an object. The clip device comprises a pair of opposed clip members including a first clip member and a second clip member; a biasing member attached to the first clip member and to the second clip member and constructed to receive and retain the tubular article; a locking post; and a locking mechanism for receiving and retaining the locking post and for retaining the pair of opposed clip members in a spaced apart closed position for retaining the tubular article in the clip device. The clip members comprise distal ends and proximal ends. The distal end of each clip member comprises a gripping area for pressing the distal ends together for opening the proximal ends; and the proximal end of each clip member comprises intermeshing teeth for clamping the clip device to the object. The locking post is made of a relatively rigid material, and the biasing member has a substantially circular body and a plurality of elongated elements for gripping the tubular article in the substantially circular body of the biasing member. The clip device is comprised of an integral construction, may be made via a molding process, and may be comprised of a plastic material.

The clip device of the invention is structured so that a tube can be inserted into the clip device even though opposed ends of the tube may be connected to further components of a system. For example, in a pneumatically actuated switching device, a pneumatic hose of the pneumatically actuated switching device may be assembled with a first end of the pneumatic hose attached to the electric switch, and the second end of the pneumatic hose attached to the pneumatic actuator. The clip device can still be attached to the pneumatic hose for its attachment to an area of the patient's bed, for example, to the bedding of the bed.

These and other aspects of the invention will be better appreciated and understood when read in light of the accompanying drawings.

### BRIEF DESCRIPTION OF THE DRAWINGS

FIG. 1 is a right hand elevation side view of a clip device of the invention in an unlocked position.

FIG. 2 is a right hand perspective view of the clip device of FIG. 1.

FIG. 3 is a left hand perspective view of the clip device of FIG. 1 retaining a tube.

FIG. 4 is a left hand elevation side view of the clip device of FIG. 1 in a locked position.

FIG. 5 is an enlarged top perspective view of the clip device of FIG. 1.

### DETAILED DESCRIPTION OF THE INVENTION

The clip device of the invention may be used in a pneumatically actuated switching device, which device, in turn, can be used in a variety of systems and environments in which it is desirable to operate an electrical circuit by remote means. The pneumatically actuated switching device is particularly well suited for use with conventional nurse call signal systems and since in this context the features of the invention are highlighted, the invention is described herein in combination with such a system. However, it should be understood that the invention is not limited to such use. The clip device of the invention is used in conjunction with a nurse's call station in that the tubing or pneumatic hose is inserted into the center of the clip device to keep the call cord (tubing) in position on the bed or in other convenient locations within a patient's area.

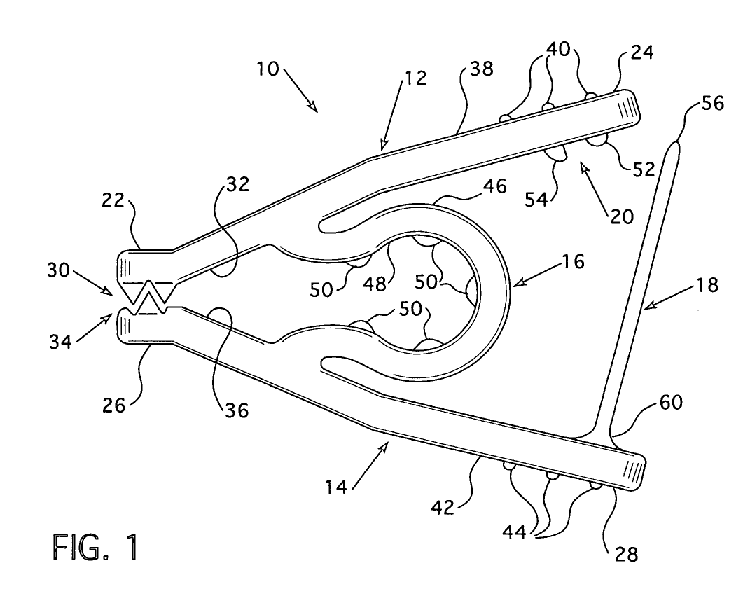

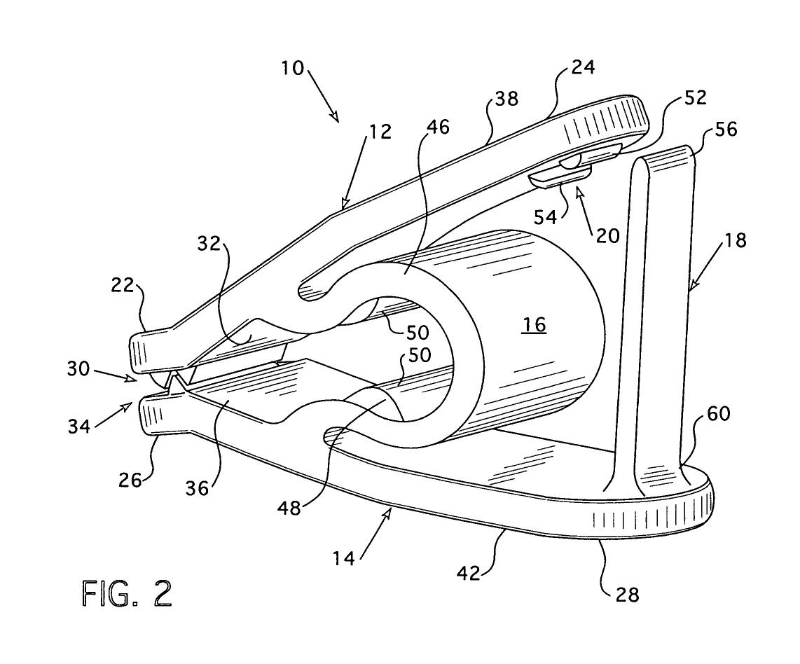

The clip device 10 of FIGS. 1, 2, 3, 4 and 5 may generally be used to secure a tube, for example, a pneumatic hose of a pneumatically actuated switching device in the area of a patient's bed. A pneumatically actuated switching device in which the clip device 10 may be used to clamp the pneumatic hose to the bedding is disclosed in the aforesaid U.S. Pat. Nos. 3,823,285 and 5,155,309, which are herein incorporated by reference in their entirety.

Referring to FIGS. 1, 2, 3, 4 and 5, the clip device 10 comprises a pair of opposed clip members including a first clip member 12 and a second clip member 14; a biasing member 16; an elongated locking post 18; and a locking mechanism 20. First clip member 12 comprises a proximal end 22 and a distal end 24; and second clip member 14 comprises a proximal end 26 and a distal end 28. A set of teeth 30 is positioned on an inner surface 32 of the proximal end 22 of first clip member 12, and a set of teeth 34 is positioned on inner surface 36 of the proximal end 26 of second clip member 14 for intermeshing with the set of teeth 30 on the inner surface 32 of the proximal end 22 and gripping an object, such as, for example, a bed sheet or blanket of the patient's bed so that the clip device 10 can be clamped and retained in the area of the patient's bed, more about which is discussed herein below.

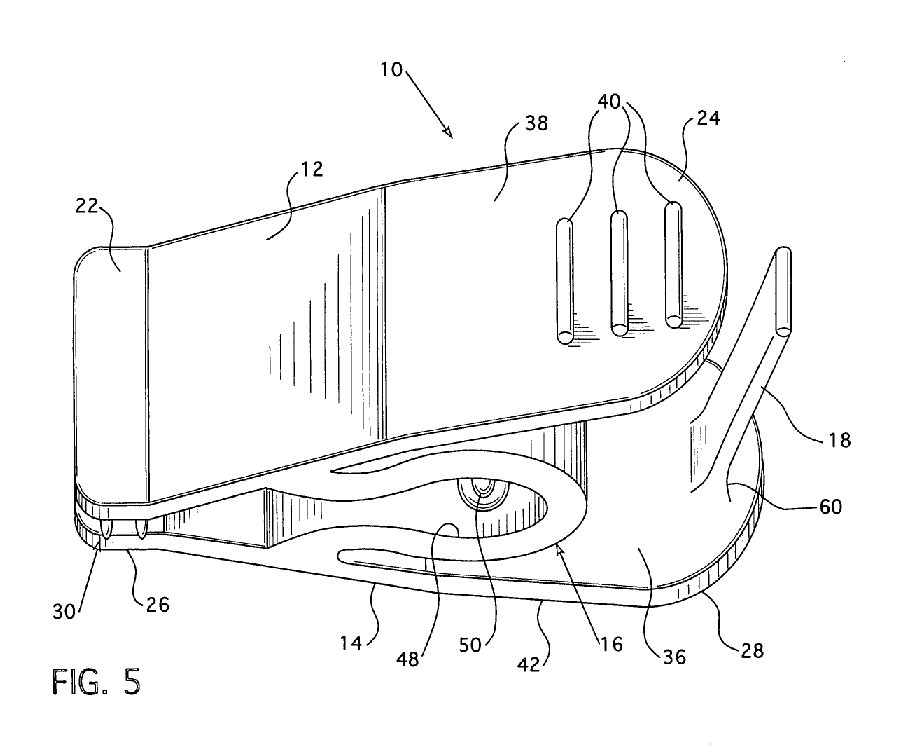

As best shown in FIGS. 1, 4 and 5, an outer surface 38 of distal end 24 of clip member 12 includes a gripping area which consists of a plurality of elongated gripping members 40 which substantially extend across the width of clip member 12 as best shown in FIG. 5. Similarly, the outer surface 42 of distal end 28 of clip member 14 includes a gripping area which consists of a plurality of elongated gripping members 44 which even though not shown, substantially extend across the width of clip member 24 in a fashion similar to elongated gripping members 40. Gripping members 40 and 44 assist the user in grasping and pressing the ends 24, 28 of clip members 12, 14 together.

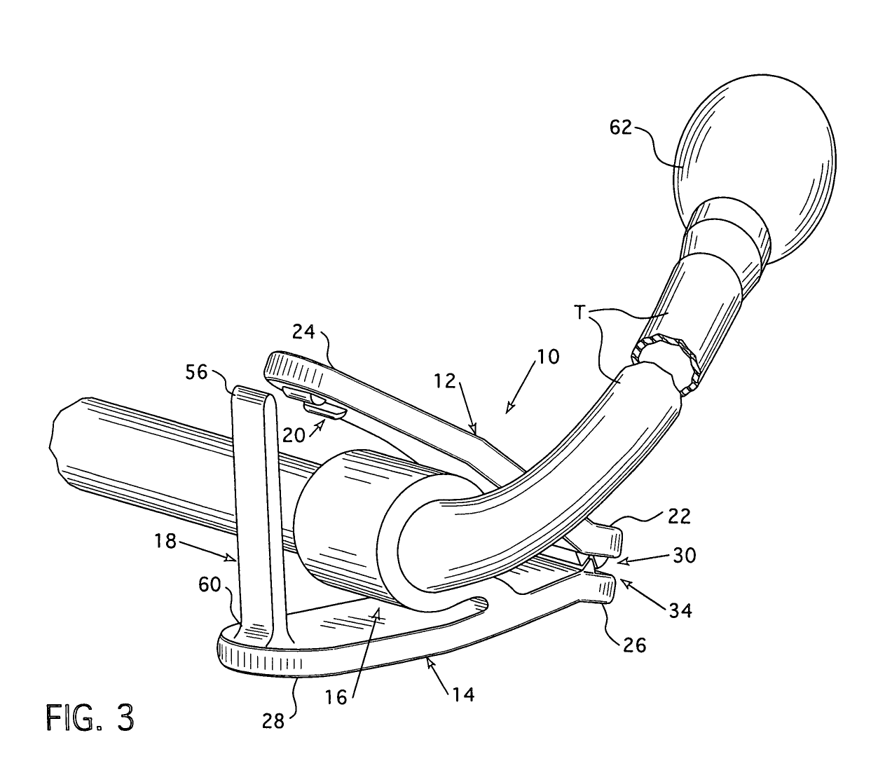

Referring particularly to FIGS. 1 through 4, the biasing member 16 is integrally connected to first clip member 12 and second clip member 14 and includes a substantially circular body 46 for receiving and retaining a tube T (FIG. 3), such as, for example, a pneumatic hose used in a pneumatically actuated switching device of the prior art discussed herein above. It is to be appreciated that circular body 46 substantially encircles tube T when tube T is inserted into and extends through circular body 46 for assuring that tube T will remain within circular body 46, and therefore, in clip device 10. An inner surface 48 of circular body 46 includes a plurality of elongated elements 50 which are positioned in a spaced-apart fashion around the circular body of biasing member 16. Even though not shown, elongated elements 50 extend substantially across the width of body 46 and function to assist in gripping tube T in position within body 46 (FIG. 3).

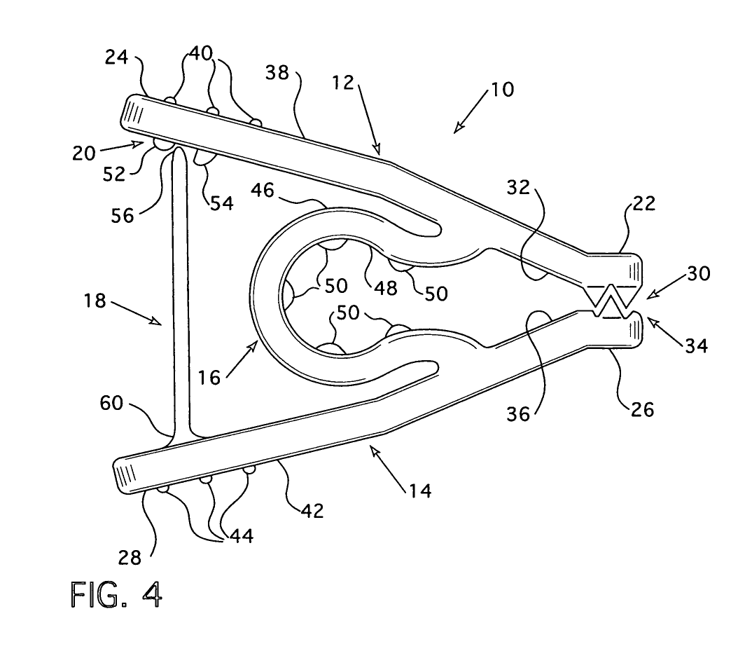

Referring again to FIGS. 1 through 5, locking mechanism 20 is located on the inner surface 32 of clip member 12 at its distal end 24 and consists of spaced-apart elongated members 52 and 54, and locking post 18 is located on an inner surface 36 of clip member 14 at its distal end 28 and is an elongated member. As best shown in FIG. 4, locking post 18 has an end 56 which enters into the space created by spaced-apart elongated members 52 and 54 of locking mechanism 20 for a locking position of clip device 10. In such a locking position of clip device 10, the proximal end 22 of first clip member 12 and the proximal end 26 of second clip member 14 are closed with the set of teeth 30 intermeshing with the set of teeth 34 and with tube T retained within the circular body 46 of biasing member 16 with the sets of teeth 30, 34 operating to grip a bed sheet or blanket to secure clip device 10 to the patient's bed. In an embodiment of the invention, locking post 18 is a relatively rigid, yet flexible member. That is, locking post 18 is rigid enough to maintain the distal end 24 of first clip member 12 and the distal end 28 of the second clip member 14 apart for a locking position of clip device 10, and yet flexible enough so that for the unlocking of clip device 10, locking post 18 can be pivoted out of position relative to locking mechanism 20.

In an embodiment of the invention, locking post 18 is an integral part of second clip member 14 with its end 60 attached to clip member 14. In a further embodiment of the invention, locking post 18 may be a separate piece of material from the remaining components of the clip device 10. In an embodiment of the invention, substantially all of the components of clip device 10 are integrally formed through an appropriate process, such as, for example, a molding process and are therefore, a one-piece unit. In an embodiment of the invention, clip device 10 is made of a plastic material. Depending on the overall dimensions of each component of clip device 10, in some embodiments of the invention, locking post may be about 1/16 inch thick, about ¼ inch wide, and about ⅞ inches long thereby making locking post flexible enough that it can engage and be disengaged from locking mechanism 20. In some embodiments, the diameter of the opening of the circular body 46 may be about 6/16 inch; the width of clip members 12 and 14 may be about 9/16 inch and the length of clip members 12 and 14 may be about 1 7/16 inches. The diameter of the tube which is to be retained by clip device 10 would be slightly less than the diameter of the opening of the circular body 46 so that the tube would fit snugly within the opening and firmly gripped by elongated clipping members 40 but not so tight as to prevent a sufficient amount of pressurized air to be delivered to the electrical switch of the pneumatically actuated switching device. In a further embodiment, the clip device 10 may be made of metal or stainless steel.

Operation of the clip device 10 is as follows: The user may grasp the distal ends 24, 28 of clip members 12, 14 with his/her fingers on elongated members 40, 44 and press clip members 12, 14 together. This action causes the proximal ends 22, 26 of clip members 12, 14 to open in a spaced-apart manner so that tube T can be inserted between the sets of teeth 30, 34 and into the circular body 46 of biasing member 16. The distal ends 24, 28 of clip members 12, 14 are then released to close proximal ends 22, 26 of clip members 12, 14 in which position, sets of teeth 30, 34 are in an intermeshed relationship and tube T extends through circular body 46. Clip device 10 while retaining tube T can then be carried to the site in which tube T is to be secured. For example, if tube T is part of a pneumatically actuated switching device and tube T is a pneumatic hose, then clip device 10 can be carried to the patient's bed area. Once again the distal ends 24, 28 of clip members 12, 14 are pressed together to open clip device 10. In this instance, the sets of teeth 30, 34 are spaced apart to receive a bed sheet or blanket and the distal ends 24, 28 are released so that the sets of teeth 30, 34 are closed to retain the bed sheet or blanket within the clip device 10. The clip device 10 is then secured in this locked position by pivoting locking post 18 away from clip device 10 and then reversing this pivoting action so that locking post 18 is engaged in the space between elongated members 52, 54 of locking mechanism 20.

Clip device 10 can be used to secure and retain tube T to an object. In a pneumatically actuated switching device, the tube T would be a pneumatic hose which would be secured to a bed sheet or blanket of the patient's bed with the deformable bulb 62 (FIG. 3) of the pneumatic actuator being placed on top the bed for operation of the pneumatic actuator by the patient, and therefore operation of the pneumatically actuated switching device in a manner known to those skilled in the art. Clip members 12 and 14 can be locked in the closed position by engaging locking post 18 in locking mechanism 20 and for retaining tube T in clip device 10.

While the present invention has been described in connection with the embodiments of the various figures, it is to be understood that other similar embodiments may be used or modifications and additions may be made to the described embodiments for performing the same function of the present invention without deviating there from. Therefore, the present invention should not be limited to any single embodiment, but rather construed in breadth and scope in accordance with the recitation of the appended claims. Even though clip device 10 is disclosed relative to securing a pneumatic hose of a pneumatically actuated switching device to a bed sheet, clip device 10 can be used in various environments for securing various tubular and/or tubular-like articles to an object.

What is claimed is:

1. A pneumatically actuated switching device having a pneumatic actuator for creating pressurized air for activating an electrical signal when the pneumatic actuator is operated and having a pneumatic hose for delivering the pressurized air to a switching device for activating the electrical signal, comprising:
a clip device for retaining and clamping the pneumatic hose to an area of the patient's bed, comprising;
a pair of opposed clip members including a first clip member and a second clip member;
a biasing member connected to the first clip member and the second clip member and having a substantially circular body for receiving and retaining the pneumatic hose;
a locking post extending from the first clip member; and
a locking mechanism located on the second clip member for receiving and retaining the locking post and retaining the pair of opposed clip members in a spaced apart position for retaining the pneumatic hose in the clip device.

2. The pneumatically actuated switching device of claim 1, wherein the first clip member comprises a proximal end; wherein the second clip member comprises a proximal end; and wherein the proximal end of the first clip member and the proximal end of the second clip member comprise intermeshing teeth for clamping the clip device to the area of the patient's bed.

3. The pneumatically actuated switching device of claim 2, wherein the first clip member comprises a distal end; wherein the second clip member comprises a distal end; and wherein the distal end of the first clip member and the distal end of the second clip member comprise a gripping area for pressing the distal ends together for opening the proximal ends of the first clip member and the second clip member for insertion and removal of the pneumatic hose from the biasing member.

4. The pneumatically actuated switching device of claim 3, wherein the biasing member comprises a plurality of elongated elements for gripping the pneumatic hose in position within the substantially circular body of the biasing member.

5. The pneumatically actuated switching device of claim 3, wherein the locking post is made of a relatively rigid material for retaining the distal end of the first clip member and the distal end of the second clip member in a spaced apart relationship when the locking post is engaged in the locking mechanism and for retaining the proximal end of the first clip member and the proximal end of the second clip member in a closed relationship for retaining the pneumatic hose within the clip device while clamping the clip device to the area of the patient's bed.

6. The pneumatically actuated switching device of claim 1, wherein the clip device is made via a molding process.

7. The pneumatically actuated switching device of claim 1, wherein the clip device is made of a plastic material.

8. A clip device for retaining and clamping an article to an object, comprising:
a pair of opposed clip members including a first clip member and a second clip member;
a biasing member connected to the first clip member and the second clip member and having a body for receiving and retaining the article;
a locking post extending from the first clip member; and
a locking mechanism located on the second clip member for receiving and retaining the locking post and retaining the pair of opposed clip members in a spaced apart position for retaining the article in the clip device and clamping the clip device to the object.

9. The clip device of claim 8, wherein the first clip member comprises a proximal end; wherein the second clip member comprises a proximal end; and wherein the proximal end of the first clip member and the proximal end of the second clip member comprises intermeshing teeth for clamping the clip device to the object.

10. The clip device of claim 9, wherein the first clip member comprises a distal end; wherein the second clip member comprises a distal end; and wherein the distal end of the first clip member and the distal end of the second clip member comprise a gripping area for pressing the distal ends together for opening the proximal ends of the first clip member and the second clip member for insertion and removal of the article from the biasing member.

11. The clip device of claim 8, wherein the biasing member comprises a plurality of elongated elements for gripping the article in position within the body of the biasing member.

12. The clip device of claim 8, wherein the locking post is made of a relatively rigid material for retaining the distal end of the first clip member and the distal end of the second clip member in a spaced apart relationship when the locking post is engaged in the locking mechanism and for retaining the proximal end of the first clip member and the proximal end of the second clip member in a closed relationship for retaining the article in the clip device and clamping the clip device to the object.

13. The clip device of claim 8, wherein the clip device is made via a molding process and is comprised of plastic.

14. The clip device of claim 8, wherein the article comprises a substantially circular article and wherein the body of the biasing member is substantially circular for receiving the substantially circular article.

15. The clip device of claim 8, wherein the clip device is comprised of an integral construction.

16. A clip device, comprising:
opposed clip members including a first clip member and a second clip member;
a locking post; and
a locking mechanism for receiving and retaining the locking post and for retaining the pair of opposed clip members in a spaced apart closed position.

17. The clip device of claim 16, wherein the first clip member comprises a distal end and a proximal end; wherein the second clip member comprises a distal end and a proximal end; wherein the distal end of each clip member comprises a gripping area for pressing the distal ends together for opening the proximal ends; and wherein the proximal ends of each clip member comprise intermeshing teeth for clamping the clip device to the object.

18. The clip device of claim 16, wherein the locking post is made of a relatively rigid material.

19. The clip device of claim 16, wherein the clip device is comprised of an integral construction.

20. The clip device of claim 16, wherein the clip device is made via a molding process and is comprised of a plastic material.
